(19) United States
(12) Patent Application Publication
(10) Pub. No.: US 2021/0165592 A1
(43) Pub. Date: Jun. 3, 2021

(54) METHOD, ELECTRONIC DEVICE AND COMPUTER PROGRAM PRODUCT FOR STORING FILES

(71) Applicant: EMC IP Holding Company LLC, Hopkinton, MA (US)

(72) Inventors: Minglong Sun, Shanghai (CN); Min Gong, Shanghai (CN); Xin Wu, Shanghai (CN); Meng Wang, Shanghai (CN)

(21) Appl. No.: 16/834,687

(22) Filed: Mar. 30, 2020

(30) Foreign Application Priority Data
Nov. 29, 2019 (CN) 201911202144.4

(51) Int. Cl. G06F 3/06

(52) U.S. Cl. CPC G06F 3/0644; G06F 3/0649; G06F 3/0683; G06F 3/0605; G06F 3/067; G06F 3/0631

(57) ABSTRACT

Embodiments of the present disclosure relate to a method, an electronic device and a computer program product for storing files. The method comprises: obtaining a preference of a user for storing a set of files in a multi-tier storage device, each tier of the multi-tier storage device being associated with a different storage cost or a different access performance; determining, based on the preference and storage costs and access performances associated with the multi-tier storage device, an evaluation for a plurality of candidate storage solutions, the candidate storage solutions indicating a storage position of a file of the set of files in the multi-tier storage device; and determining, from the plurality of candidate storage solutions, a target storage solution for storing the set of files based on the evaluation. Embodiments of the present disclosure can automatically provide the storage solution that fits the user's preference for the user.

### RELATED APPLICATION

The present application claims the benefit of priority to Chinese Patent Application No. 201911202144.4, filed on Nov. 29, 2019, which application is hereby incorporated into the present application by reference herein in its entirety.

### FIELD

Embodiments of the present disclosure relate to the field of computers, and more specifically, a method, an electronic device and a computer program product for storing files.

### BACKGROUND

In recent years, various types of storage devices have been developed along with advances in computer technology. These different types of storage devices may have different access performances or storage costs. For example, although solid-state disks have higher access performance than mechanical hard disks, their storage costs are also huge. Storage service providers may provide personalized storage services for users with different types of storage devices. Users may select different types of storage devices meeting the storage requirement for files or data at different levels. However, the users usually need to store massive files or data and manually assign the types of the storage devices for storing files which provides a bad user experience.

### SUMMARY

Embodiments of the present disclosure provide a solution for storing files.

In accordance with a first aspect of the present disclosure, there is provided a method for storing files. The method comprises: obtaining a preference of a user for storing a set of files in a multi-tier storage device, each tier of the multi-tier storage device being associated with a different storage cost or a different access performance; determining, based on the preference and storage costs and access performances associated with the multi-tier storage device, an evaluation for a plurality of candidate storage solutions, the candidate storage solutions indicating a storage position of a file of the set of files in the multi-tier storage device; and determining, from the plurality of candidate storage solutions, a target storage solution for storing the set of files based on the evaluation.

In accordance with a second aspect of the present disclosure, there is provided an electronic device. The electronic device comprises: at least one processing unit; at least one memory coupled to the at least one processing unit and storing instructions for execution by the at least one processing unit, the instructions, when executed by the at least one processing unit, cause the device to perform acts comprising: obtaining a preference of a user for storing a set of files in a multi-tier storage device, each tier of the multi-tier storage device being associated with a different storage cost or a different access performance; determining, based on the preference and storage costs and access performances associated with the multi-tier storage device, an evaluation for a plurality of candidate storage solutions, the candidate storage solutions indicating a storage position of a file of the set of files in the multi-tier storage device; and determining, from the plurality of candidate storage solutions, a target storage solution for storing the set of files based on the evaluation.

In accordance with a third aspect of the present disclosure, there is provided a computer program product being stored in a non-transitory computer storage medium and comprising machine-executable instructions which, when executed by a device, cause the device to perform the method of the first aspect of the present disclosure.

This Summary is provided to introduce a selection of concepts in a simplified form that are further described below in the Detailed Description. This Summary is not intended to identify key features or essential features of the present disclosure, nor is it intended to be used to limit the scope of respective embodiments of the present disclosure.

### BRIEF DESCRIPTION OF THE DRAWINGS

Through the following more detailed description of the example embodiments of the present disclosure with reference to the accompanying drawings, the above and other objectives, features, and advantages of the present disclosure will become more apparent, wherein the same reference sign usually refers to the same component in the example embodiments of the present disclosure.

FIG. 1 illustrates a schematic diagram of an environment where embodiments of the present disclosure can be implemented;

FIG. 2 illustrates a flowchart of a process of storing files according to some embodiments of the present disclosure;

FIG. 3 illustrates a flowchart of a process of determining a preference according to some embodiments of the present disclosure;

FIG. 4 illustrates a flowchart of a process of determining an evaluation according to some embodiments of the present disclosure; and

FIG. 5 illustrates a schematic diagram of an example device for implementing embodiments of the present disclosure.

### DETAILED DESCRIPTION OF EMBODIMENTS

Embodiments of the present disclosure will be described in more detail below with reference to the drawings. Although the drawings illustrate the embodiments of the present disclosure, it should be appreciated that the present disclosure can be implemented in various manners and should not be limited to the embodiments explained herein. On the contrary, the embodiments are provided to make the present disclosure more thorough and complete and to fully convey the scope of the present disclosure to those skilled in the art.

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The terms “one example embodiment” and “one embodiment” are to be read as “at least one example embodiment.” The term “a further embodiment” is to be read as “at least a further embodiment.” The terms “first”, “second” and so on can refer to same or different objects unless otherwise indicated.

In recent years, various types of storage devices have been developed along with the advances in computer technology. These different types of storage devices may have different access performances or storage costs. For example, although solid-state disks have higher access performance than mechanical hard disks, their storage costs are also huge. Storage service providers may provide personalized storage services for users with different types of storage devices, which may be referred to as multi-tier storage devices.

In a multi-tier storage device-based scenario, users may select different types of storage devices for files or data of different importance levels. For example, the users may expect to store files of a higher importance level using storage devices with higher access performance Conversely, the users may expect to lower the storage costs of the data that are accessed less frequently. However, the users usually need to store massive files or data, so it is hard for the users to effectively assign the storage device type for storing each file.

According to embodiments of the present disclosure, there is provided a solution for storing files. In this solution, a preference of a user for storing a set of files in a multi-tier storage device may be obtained in the first place. Each tier of the multi-tier storage device is associated with a different storage cost or a different access performance Then, the preference and storage costs and access performances associated with the multi-tier storage device may be used to determine an evaluation for a plurality of candidate storage solutions. The candidate storage solutions may indicate a storage position of a file of the set of files in the multi-tier storage device. A target storage solution may be determined from the plurality of candidate storage solutions according to the evaluation. In this way, embodiments of the present disclosure can automatically determine a storage solution that satisfies the user's preference, thereby reducing the operating burden on the users.

Embodiments of the present disclosure are described in details below with reference to the drawings.

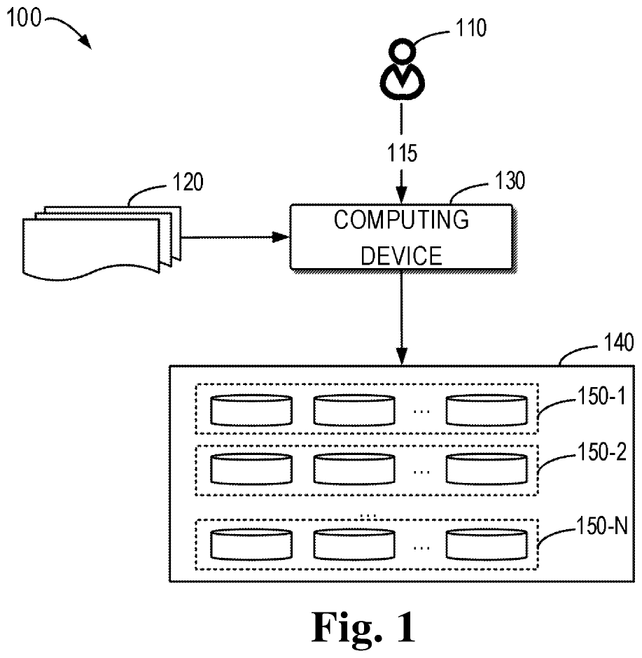

FIG. 1 illustrates a schematic diagram of an example environment 100 where a plurality of embodiments of the present disclosure can be implemented. As shown, the environment 100 may include a computing device 130 and a multi-tier storage device 140 coupled to the computing device 130. The multi-tier storage device 140 may include different levels of storage device groups 150-1, 150-2 to 150-N composed of storage devices of the same type (individually or collectively known as “storage device group 150”). The storage devices in each storage device group 150 may have a different storage cost or an access performance. For example, the storage device group 150-1 may include storage devices having highest storage cost and lowest access latency while the storage device group 150-N may include storage devices with lowest storage cost and highest access latency.

The computing device 130 may receive a set of files 120 required for storage in the multi-tier storage device 140. The set of files 120 may include one or more files or data blocks to be stored. The computing device 130 may further receive, from a user 110, a preference 115 of the user 110 for storage approach of the set of files 120 and determine, based on the preference 115, a storage device group 150 to which the file in the set of files 120 should be stored in the multi-tier storage device 140. A process of determining a storage solution on the basis of the preference 115 will be described in detail below.

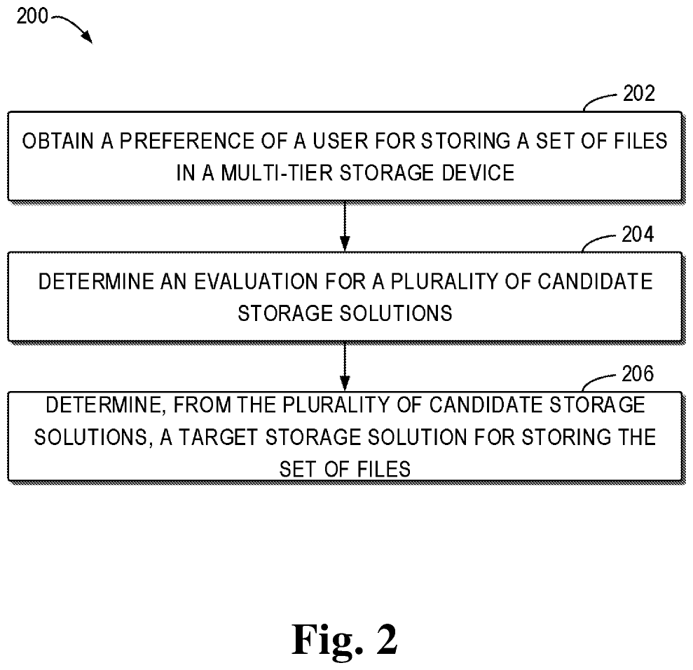

A process of storage management according to embodiments of the present disclosure is described below with reference to FIGS. 2 to 4. FIG. 2 illustrates a flowchart of a process 200 of storing files according to some embodiments of the present disclosure. For example, the process 200 may be implemented by the computing device 130 shown in FIG. 1.

At block 202, the computing device 130 obtains a preference 115 of a user 110 for storing a set of files 120 in a multi-tier storage device 140, where each tier of the multi-tier storage device 140 is associated with a different storage cost or a different access performance In some embodiments, the preference 115 may indicate that the user 110 is more concerned with storage cost or access performance.

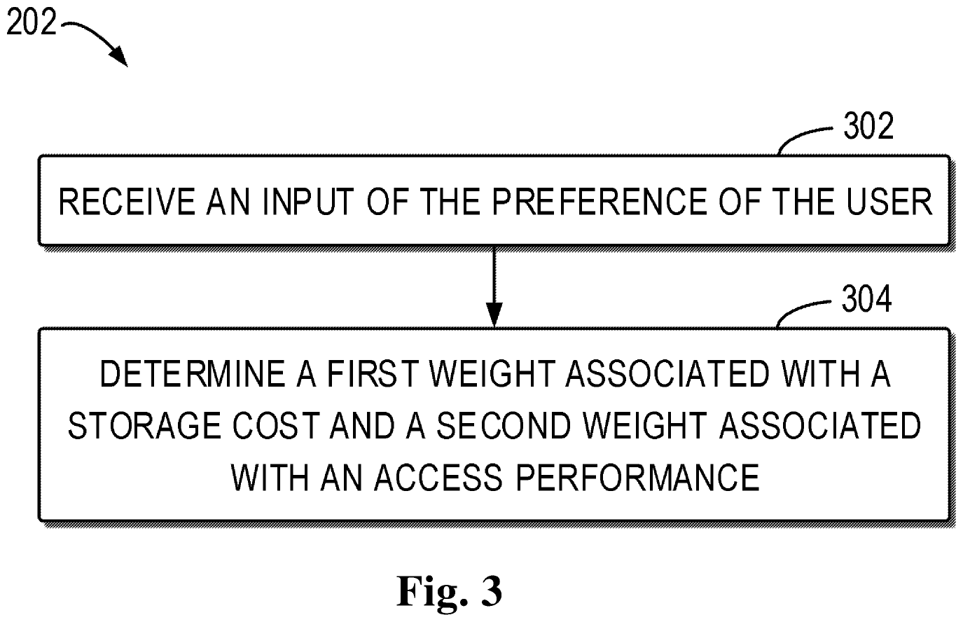

In some embodiments, the computing device 130 may obtain the preference based on the input of the user 110. Specifically, FIG. 3 illustrates a flowchart of a process of determining the preference according to embodiments of the present disclosure.

As shown in FIG. 3, the computing device 130 may receive an input of the user 110 for the preference 115 at block 302. In some embodiments, the computing device 130, for example, may provide an interface for the user 110 to input the preference 150. For example, the computing device 130 may provide a dragging bar for the user 110 to input the preference. In response to receiving a dragging operation on a slider in the dragging bar by the user 110, the computing device 130 may determine the preference 115 of the user 110 for storage cost and access performance In another example, the user 110 may also directly input respective preference values for the storage cost and the access performance to the computing device 130. For example, the user 110 may input a preference value of 80 for the storage cost and 20 for the access performance, so as to indicate that the user 110 cares more about the storage cost. It should be understood that the above example inputs are exemplary only and the preference 115 of the user 100 for storage may also be received in any other suitable manner and the present disclosure is not restricted in this regard.

At block 304, the computing device 130 may determine, based on the input, the first weight associated with the storage cost and the second weight associated with the access performance as indications for the preference 115. In some embodiments, after obtaining the input of the user 110, the computing device 130 may further determine a normalized weight associated with the storage cost and the access performance. For example, the computing device 130 may determine respective weights based on the position of the slider in the dragging bar. In another example, the computing device 130, for example, may calculate respective weights based on the preference values input by the user 110. In the example where the preference value of the storage cost is 80 and the preference value of the storage performance is 20, the first weight associated with the storage cost may be determined as 0.8 while the second weight may be determined as 0.2.

Continuing to refer to FIG. 2, at block 204, the computing device 130 determines, based on the preference 115 and the storage costs and the access performances associated with the multi-tier storage device 140, an evaluation for a plurality of candidate storage solutions, where the candidate storage solutions indicate a storage position of a file of the set of files 120 in the multi-tier storage device 140. In some embodiments, the candidate storage solutions may include all possible solutions composed of different storage positions of the files of the set of files 120 in the multi-tier storage device 140 (i.e., storage devices of different tiers to which the files are stored) in whole or in part.

In some embodiments, the preference 115 may include an indication of the first storage position of the first file of the set of files 120 by the user 110. For example, the user 110 may customize a particular storage position for a part of the files in the set of files 120. In some embodiments, the computing device 130 may determine the plurality of candidate storage solutions based on the first storage position, such that each candidate storage solution indicates that the first file is to be stored at the first storage position. Accordingly, in addition to automatically providing storage solutions, embodiments of the present disclosure also support the user to set the storage position of the particular file.

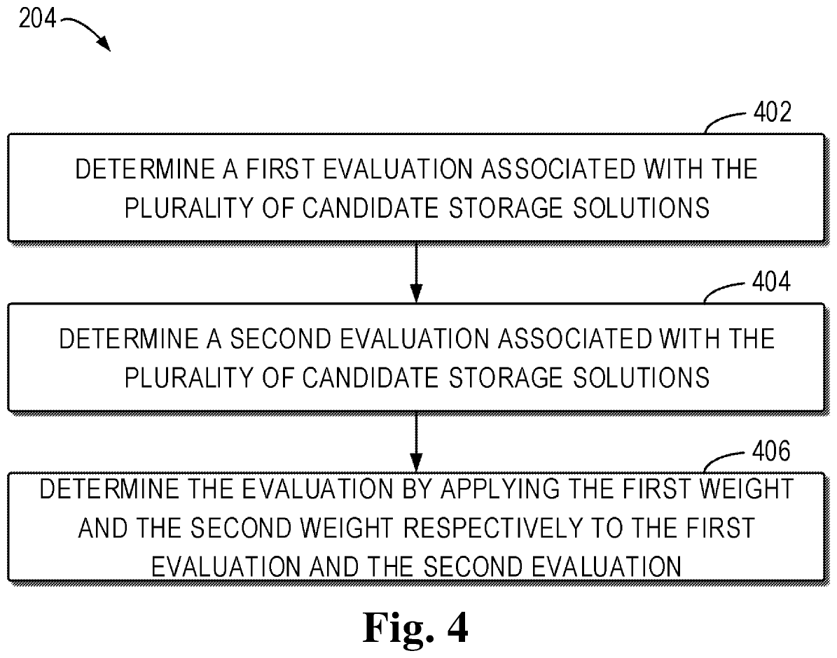

In some embodiments, when the preference 115 includes the first weight associated with the storage cost and the second weight associated with the access performance, the computing device 130 may determine an evaluation by considering both the first and second weights. Specifically, FIG. 4 illustrates a flowchart of a process of determining an evaluation according to embodiments of the present disclosure.

As shown in FIG. 4, the computing device 130 may determine, based on the storage costs associated with the multi-tier storage device 140, the first evaluation associated with the plurality of candidate storage solutions at block 402.

Continuing with the example of FIG. 1, each candidate storage solution will assign respective storage device groups 150 to which each file in the set of files 120 should be stored. The computing device 130 may determine the storage cost of each file based on the size of each file in the set of files 120 and the storage cost of the corresponding storage device group 150 (e.g., price per unit). The computing device 130 may determine, based on the cost of each file, an overall storage cost as the first evaluation. It should be appreciated that the first evaluation may just be a possible price for storing the set of files 120 according to the storage solution.

At block 404, the computing device 130 may determine, based on the access performances associated with the multi-tier storage device 140, the second evaluation associated with the plurality of candidate storage solutions. In some embodiments, the computing device 130 may determine the second evaluation using the access latency of the set of files 120 stored to the multi-tier storage device 140.

In some embodiments, the computing device 130 may determine, based on the access performances associated with each tier of the multi-tier storage device, the access latency of a file in the set of files 120. For example, the computing device 130 may determine the access latency of each file according to the size of each file in the set of files 120 and the access performance of the corresponding storage device group 150.

In some embodiments, the computing device 130 may also determine the probability that the file is to be accessed based on at least one of the last modification time, size, type and position of the file. In some embodiments, the computing device 130 may calculate the probability according to the above factors using a function-based calculation approach. For example, the probability may be determined as a function for the above factors via function fitting based on historical data. Generally speaking, the more recent the last modification time is, the more likely the file is to be accessed.

In some embodiments, the computing device 130 may also build a model between the above factors and the probability using machine learning and determine the probability that each file is to be accessed using the trained model. It should be understood that the probability that the file is to be accessed may also be determined in other suitable manners and the present disclosure is not restricted in this regard.

In some embodiments, the computing device 130 then determines the second evaluation based on the access latency and the probability. Specifically, the second evaluation, for example, may be determined as a sum of products of the access latency of each file in the set of files 120 and the corresponding access probabilities. According to such a calculation, the second evaluation may indicate the access latency of the files in the set of files 120.

At block 406, the computing device 130 may determine the evaluation by applying the first weight and the second weight to the first evaluation and the second evaluation, respectively. The computing device 130 may determine the evaluation by calculating the weighted sum of the first evaluation and the second evaluation. The evaluation determined by the above approach can both comprehensively reflect the storage cost and the access performance and embody the preference of the user for these two.

Continuing to refer to FIG. 2, the computing device 130 determines, from the plurality of candidate storage solutions, a target storage solution for storing the set of files 120 based on the evaluation at block 206. In some embodiments, the computing device 130 may select the storage solution with a value of the evaluation below a predetermined threshold as the target storage solution. Alternatively, the computing device 130 may select the storage solution with the minimum value of the evaluation as the target storage solution.

In some embodiments, instead of selecting all possible solutions, the computing device 130 may select a plurality of candidate storage solutions as the candidate solutions by using Integer Programming The computing device 130 may further determine a target storage solution from a fewer number of candidate storage solutions based on the evaluation. In this way, embodiments of the present disclosure may further lower the computation overheads of the computing device 130. The detailed principle of Integer Programming is not elaborated herein.

In some embodiments, the preference 115 may also include the first constraint over the overall storage cost by the user 110. It should be understood that the computing device 130 may determine the first constraint from the input of the user 110 for the preference 115. In this example, before calculating the evaluation of the candidate storage solutions, the computing device 130 may determine whether the overall storage cost corresponding to the candidate storage solution satisfies the first constraint. The computing device 130 may only consider the candidate storage solutions satisfying the first constraint and picks up, for example, a solution with the minimum value of the evaluation as the target storage solution.

In some embodiments, the preference 115 may also include the second constraint over the overall access performance by the user 110. It should be understood that the computing device 130 may determine the second constraint from the input of the user 110 for the preference 115. In this example, before calculating the evaluation of the candidate storage solutions, the computing device 130 may determine whether the overall access performance (e.g., represented by access latency) corresponding to the candidate storage solution satisfies the second constraint. The computing device 130 may only consider the candidate storage solutions satisfying the second constraint and pick up for example a solution with the minimum value of the evaluation as the target storage solution.

In some embodiments, the process 200 may also include storing the set of files 120 to the multi-tier storage device 140 based on the target storage solution. Specifically, after the target storage solution is determined, the computing device 130 may add, based on the target storage solution, a label indicative of a corresponding storage position for a file in the set of files. For example, the file stored to the storage device group 150-1 is added with label “1.” Afterwards, the computing device 130 may generate, based on the label, a storage rule for each file in the set of files 120, and store the files in the set of files 120 into corresponding storage device groups 150 of the multi-tier storage device 140 based on the storage rule. For example, the computing device 130 may check the label of each file and store the file to the corresponding storage device group 150 according to the relation between the label and the storage device group 150 in the multi-tier storage device 140. In this way, embodiments of the present disclosure can be compatible with the storage system that determine the storage position of each file based on the storage rule of a user's input in a better way, thereby improving usability of the solution of the present disclosure.

It can be observed that embodiments of the present disclosure can automatically customize a storage solution that fits a user's preference based on the general preference of the user through the above described solution. Therefore, the present disclosure lightens the burden of customizing the storage solution of the set of files on the user and provides a storage solution that fits the user's preference through evaluating the candidate solutions

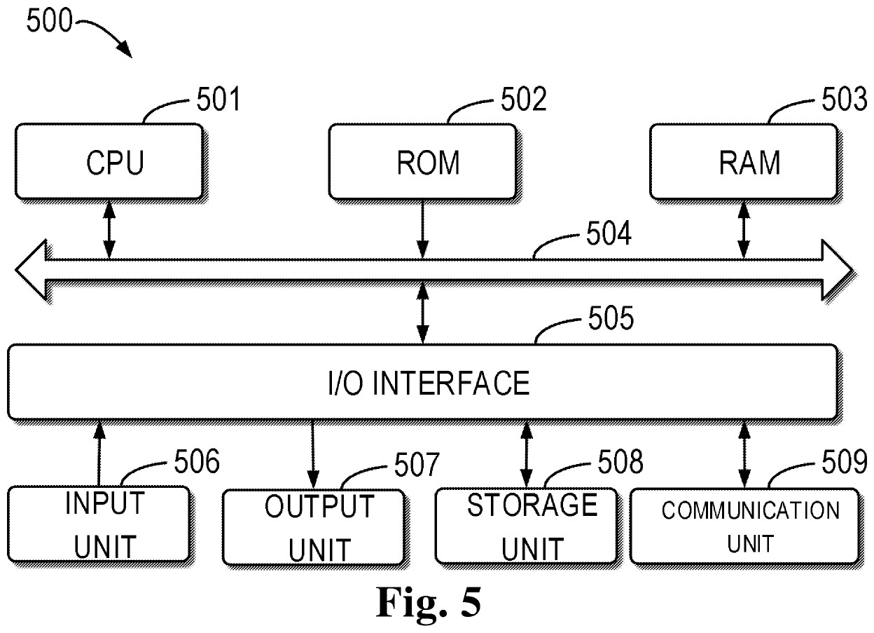

FIG. 5 illustrates a schematic block diagram of an example device 500 for implementing embodiments of the present disclosure. For example, the computing device 130 according to embodiments of the present disclosure may be implemented by the device 500. As shown, the device 500 includes a central processing unit (CPU) 501, which can execute various suitable actions and processing based on the computer program instructions stored in a read-only memory (ROM) 502 or computer program instructions loaded in the random-access memory (RAM) 503 from a storage unit 508. The RAM 503 may also store all kinds of programs and data required by the operations of the device 500. The CPU 501, ROM 502 and RAM 503 are connected to each other via a bus 504. The input/output (I/O) interface 505 is also connected to the bus 504.

A plurality of components in the device 500 is connected to the I/0 interface 505, including: an input unit 506, such as a keyboard, a mouse and the like; an output unit 507, e.g., various kinds of displays and loudspeakers etc.; a storage unit 508, such as a drive and an optical drive etc.; and a communication unit 509, such as a network card, a modem, a wireless transceiver and the like. The communication unit 509 allows the device 500 to exchange information/data with other devices via the computer network, such as Internet, and/or various telecommunication networks.

The above described process and processing, such as process 200, can be executed by the processing unit 501. For example, in some embodiments, the process 200 may be implemented as a computer software program tangibly included in the machine-readable medium, e.g., storage unit 508. In some embodiments, the computer program may be partially or fully loaded and/or mounted to the device 500 via the ROM 502 and/or communication unit 509. When the computer program is loaded to the RAM 503 and executed by the CPU 501, one or more steps of the above described process 200 can be implemented.

The present disclosure can be a method, a device, a system and/or a computer program product. The computer program product may include a computer-readable storage medium, on which the computer-readable program instructions for executing various aspects of the present disclosure are loaded.

The computer-readable storage medium may be a tangible apparatus that maintains and stores instructions utilized by the instruction executing devices. The computer-readable storage medium may be, but is not limited to, an electrical storage device, a magnetic storage device, an optical storage device, an electromagnetic storage device, a semiconductor storage device or any appropriate combinations of the above. More concrete examples of the computer-readable storage medium (non-exhaustive list) include: a portable computer drive, a hard drive, a random-access memory (RAM), a read-only memory (ROM), an erasable programmable read-only memory (EPROM or flash), a static random-access memory (SRAM), a portable compact disk read-only memory (CD-ROM), a digital versatile drive (DVD), a memory stick, a floppy drive, mechanical coding devices, a punched card stored with instructions thereon, or a projection in a slot, and any appropriate combinations of the above. The computer-readable storage medium utilized herein is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instructions herein may be downloaded from the computer-readable storage medium to each computing/processing device, or to an external computer or external storage via Internet, a local area network, a wide area network and/or a wireless network. The network may include copper-transmitted cables, optical fiber transmission, wireless transmission, routers, firewall, switches, network gate computers and/or edge servers. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure may be assembly instructions, instructions of instruction set architecture (ISA), machine instructions, machine-related instructions, microcodes, firmware instructions, state setting data, or source codes or target codes written in any combination of one or more programming languages, where the programming languages include object-oriented programming languages, such as Smalltalk, C++and the like, and conventional procedural programming languages, e.g., “C” language or similar programming languages. The computer-readable program instructions may be implemented fully on a user's computer, partially on the user's computer, as an independent software package, partially on the user's computer and partially on a remote computer, or completely on the remote computer or a server. In the case where a remote computer is involved, the remote computer may be connected to the user's computer via any type of networks, including a local area network (LAN) and a wide area network (WAN), or to an external computer (e.g., connected via Internet using the Internet service provider). In some embodiments, state information of the computer-readable program instructions is used to customize an electronic circuit, e.g., a programmable logic circuit, a field programmable gate array (FPGA) or a programmable logic array (PLA). The electronic circuit may execute computer-readable program instructions to implement various aspects of the present disclosure.

Flowcharts and/or block diagrams of a method, a device (system) and a computer program product according to embodiments of the present disclosure describe various aspects of the present disclosure. It should be appreciated that each block of the flowcharts and/or block diagrams and the combination thereof can be implemented by computer-readable program instructions.

The computer-readable program instructions may be provided to the processing unit of a general-purpose computer, a dedicated computer or other programmable data processing devices to manufacture a machine, such that the instructions which, when executed by the processing unit of the computer or other programmable data processing devices, generate a device for implementing functions/acts stipulated in one or more blocks in the flow chart and/or block diagram. The computer-readable program instructions may also be stored in the computer-readable storage medium and cause the computer, programmable data processing device and/or other devices to work in a particular manner, such that the computer-readable medium stored with instructions includes an article of manufacture, including instructions for implementing various aspects of the functions/acts stipulated in one or more blocks of the flow chart and/or block diagram.

The computer-readable program instructions may also be loaded into the computer, other programmable data processing devices or other devices, so as to execute a series of operation steps on the computer, other programmable data processing apparatuses or other devices to generate a computer-implemented process. Therefore, the instructions executed on the computer, other programmable data processing devices or other devices implement functions/acts stipulated in one or more blocks of the flow chart and/or block diagram.

The flow chart and block diagram in the drawings illustrate system architecture, functions and operations that may be implemented by the device, method and computer program product according to the plurality of implementations of the present disclosure. In this regard, each block in the flow chart or block diagram can represent a module, a part of program segment or code, where the module and the part of program segment or code include one or more executable instructions for performing stipulated logic functions. In some alternative implementations, it should be noted that the functions indicated in the block may also take place in an order different from the one indicated in the drawings. For example, two successive blocks may be in fact executed in parallel or sometimes in a reverse order depending on the involved functions. It should also be noted that each block in the block diagram and/or flow chart and combinations of the blocks in the block diagram and/or flow chart may be implemented by a hardware-based system exclusive for executing stipulated functions or actions, or by a combination of dedicated hardware and computer instructions.

Various implementations of the present disclosure have been described above and the above description is for the purpose of illustration rather than exhaustive and is not limited to the implementations of the present disclosure. Many modifications and alterations, without deviating from the scope and spirit of the explained various implementations, are obvious for those skilled in the art. The selection of terms in the text aims to best explain principles and actual applications of each implementation and technical improvements made in the market by each implementation, or enable others of ordinary skill in the art to understand implementations of the present disclosure.

I/We claim:

1. A method, comprising:
obtaining, by a system comprising a processor, a preference of a user for storing a set of files in a multi-tier storage device, each tier of the multi-tier storage device being associated with a different storage cost or a different access performance;
determining, based on the preference, the different storage costs and the different access performances associated with the multi-tier storage device, an evaluation for a plurality of candidate storage solutions, the candidate storage solutions indicating a storage position of a file of the set of files in the multi-tier storage device; and
determining, from the plurality of candidate storage solutions, a target storage solution for the storing of the set of files based on the evaluation.

2. The method of claim 1, wherein the obtaining the preference comprises:
receiving an input of the preference of the user; and
determining, based on the input, a first weight associated with a storage cost of the different storage costs and a second weight associated with an access performance of the different access performances.

3. The method of claim 2, wherein the determining the evaluation comprises:
determining, based on the different storage costs associated with the multi-tier storage device, a first evaluation associated with the plurality of candidate storage solutions;
determining, based on the different access performances associated with the multi-tier storage device, a second evaluation associated with the plurality of candidate storage solutions; and
determining the evaluation by applying the first weight and the second weight to the first evaluation and the second evaluation, respectively.

4. The method of claim 3, wherein the determining the second evaluation comprises:
determining, based on the different access performances associated with each tier of the multi-tier storage device, an access latency of a file in the set of files;
determining a probability that the file is to be accessed based on at least one of a last modification time, a size, a type and a position of the file; and
determining, based on the access latency and the probability, the second evaluation.

5. The method of claim 1, wherein the preference comprises a constraint over an overall storage cost by the user, and wherein the determining the target storage solution comprises:
selecting the target storage solution from the plurality of candidate storage solutions, such that the overall storage cost associated with the target storage solution satisfies the constraint.

6. The method of claim 1, wherein the preference comprises a constraint over an overall access performance by the user, and wherein the determining the target storage solution comprises:
selecting the target storage solution from the plurality of candidate storage solutions, such that the overall access performance associated with the target storage solution satisfies the constraint.

7. The method of claim 1, wherein the preference comprises an indication of a first storage position for a first file of the set of files by the user, and the method further comprises:
determining, based on the first storage position, the plurality of candidate storage solutions, wherein each of the plurality of candidate storage solutions indicates that the first file is to be stored at the first storage position.

8. The method of claim 1, further comprising:
adding, based on the target storage solution, a label indicative of a corresponding storage position for a file in the set of files; and
storing, based on the label, the set of files into the multi-tier storage device.

9. A device, comprising:
at least one processing unit;
at least one memory coupled to the at least one processing unit and storing instructions for execution by the at least one processing unit, the instructions, when executed by the at least one processing unit, cause the device to perform acts comprising:
obtaining a preference of a user for storing a set of files in a multi-tier storage device, each tier of the multi-tier storage device being associated with a different storage cost or a different access performance;
determining, based on the preference, the different storage costs, and the different access performances associated with the multi-tier storage device, an evaluation for a plurality of candidate storage solutions, the candidate storage solutions indicating a storage position of a file of the set of files in the multi-tier storage device; and
determining, from the plurality of candidate storage solutions, a target storage solution for the storing of the set of files based on the evaluation.

10. The device of claim 9, wherein the obtaining the preference comprises:
receiving an input of the preference of the user; and
determining, based on the input, a first weight associated with a storage cost and a second weight associated with an access performance.

11. The device of claim 10, wherein determining the evaluation comprises:
determining, based on the different storage costs associated with the multi-tier storage device, a first evaluation associated with the plurality of candidate storage solutions;
determining, based on the different access performances associated with the multi-tier storage device, a second evaluation associated with the plurality of candidate storage solutions; and
determining the evaluation by applying the first weight and the second weight to the first evaluation and the second evaluation, respectively.

12. The device of claim 11, wherein the determining the second evaluation comprises:
determining, based on access performances associated with each tier of the multi-tier storage device, an access latency of a file in the set of files;
determining a probability that the file is to be accessed based on at least one of a last modification time, a size, a type and a position of the file; and
determining, based on the access latency and the probability, the second evaluation.

13. The device of claim 9, wherein the preference comprises a constraint over an overall storage cost by the user, and wherein the determining the target storage solution comprises:
selecting the target storage solution from the plurality of candidate storage solutions, such that the overall storage cost associated with the target storage solution satisfies the constraint.

14. The device of claim 9, wherein the preference comprises a constraint over an overall access performance by the user, and wherein determining the target storage solution comprises:
selecting the target storage solution from the plurality of candidate storage solutions, such that the overall access performance associated with the target storage solution satisfies the constraint.

15. The device of claim 9, wherein the preference comprises an indication of a first storage position for a first file of the set of files by the user, and the method further comprises:
determining, based on the first storage position, the plurality of candidate storage solutions, wherein each of the plurality of candidate storage solutions indicates that the first file is to be stored at the first storage position.

16. The device of claim 9, wherein the acts further comprise:
adding, based on the target storage solution, a label indicative of a corresponding storage position for a file in the set of files; and
storing, based on the label, the set of files into the multi-tier storage device.

17. A computer program product being stored in a non-transitory computer storage medium and comprising machine-executable instructions which, when executed by a device, cause the device to perform operations comprising:
obtaining a user preference of for storage of files in a multi-tier storage device comprising tiers, wherein the tiers comprise respective storage costs or different access performances;
determining, based on the preference, the respective storage costs and the respective access performances associated with the multi-tier storage device, an evaluation for candidate storage solutions indicating a storage position of a file of the files in the multi-tier storage device; and
determining, from the candidate storage solutions, a target storage solution for the storage of the files based on the evaluation.

18. The computer program product of claim 17, wherein the obtaining the preference comprises:
receiving an input of the user preference; and
determining, based on the input, a first weight associated with a storage cost of the respective storage costs and a second weight associated with an access performance of the respective access performances,
wherein the determining the evaluation comprises:
determining, based on the respective storage costs associated with the multi-tier storage device, a first evaluation associated with the candidate storage solutions;
determining, based on the respective access performances associated with the multi-tier storage device, a second evaluation associated with the candidate storage solutions, wherein the determining the second evaluation comprises:
determining, based on the respective access performances associated with each tier of the multi-tier storage device, an access latency of the file in the files;
determining a probability that the file is to be accessed based on at least one of a last modification time, a size, a type and a position of the file; and
determining, based on the access latency and the probability, the second evaluation; and
determining the evaluation by applying the first weight and the second weight to the first evaluation and the second evaluation, respectively.

19. The computer program product of claim 17, wherein the preference comprises a first constraint over an overall storage cost by a user or a second constraint over an overall access performance by the user, and wherein determining the target storage solution comprises:
selecting the target storage solution from the candidate storage solutions, such that the overall storage cost associated with the target storage solution satisfies the first constraint or the overall access performance associated with the target storage solution satisfies the second constraint.

20. The computer program product of claim 17, wherein the preference comprises an indication of a first storage position for a first file of the files by a user, and the operations further comprise:
determining, based on the first storage position, the plurality of candidate storage solutions, wherein each of the plurality of candidate storage solutions indicates that the first file is to be stored at the first storage position.
